(19) United States
(12) Patent Application Publication
(10) Pub. No.: US 2010/0068373 A1
(43) Pub. Date: Mar. 18, 2010

(54) Sugar extraction process

(76) Inventor: William N. Buchele, Los Gatos, CA (US)

Correspondence Address: William N. Buchele, 18067 Reed Knoll Rd., Los Gatos, CA, 95033, US

(21) Appl. No.: 12/283,849

(22) Filed: Sep. 16, 2008

(51) Int. Cl. A23L 1/307; A23L 1/28; B04B 15/10; B01D 33/06; B04B 3/00

(52) U.S. Cl. 426/655; 210/787; 210/360.1; 210/791

(57) ABSTRACT

Equipment to extract excess sugar from fruit juice using a centrifuge containing reusable sugar absorbing materials is presented. A method comprising repeatedly performing successive extraction and cleaning cycles on successive portions of juice is also presented. The method's extraction cycle involves extracting the sugar from the juice. The cleaning cycle includes removing the extracted sugar from the sugar absorbing material with hot and cold water, and both cycles include removing all the liquid out of the centrifuge by introducing an inert gas under pressure into the centrifuge at the end of each respective cycle.

### FIELD OF THE INVENTION

The present invention pertains to the reduction of the sugar content of fruit juice, in one case grape juice in the production of wine, through the selective molecular bonding of sugar and pressurized extraction of the residual juice from the sugar absorption material.

### BACKGROUND OF THE INVENTION

Over many years the alcohol content of wine has gradually increased. A few decades ago the alcohol content was typically 11.5% to 12.5% by volume. Today many wines are sold in the 14% to 15.5% range with some ranging even higher. The increase is driven by the preferences of consumers for ripe fruit flavors, improved viniculture methods and new strains of yeast that convert sugar more efficiently into alcohol. Other causes such as plating grapes in warmer climates also contribute, on average, to higher sugar and resulting alcohol. On the other hand, there is a desire by consumers, resulting in a perceived need recognized by the wine industry, for high quality, reduced alcohol content wines.

Toward this end, millions of gallons of wine are processed worldwide every year to reduce alcohol. Following the fermentation of the juice into wine, methods such as reverse-osmosis and “spinning cones” are utilized to directly remove alcohol from wine. These means require processing at a facility with a distillers license since pure alcohol is extracted. A significant fraction of the volatile aroma compounds are extracted along with the alcohol. These must be isolated and reintroduced to the wine to maintain the quality of the low alcohol wine, but such isolation and reintroduction is costly.

Other well-known means for producing lower alcohol wines include harvesting the fruit early to ensure lower sugar content and diluting the juice with water. These techniques generally result in wines with less than optimal qualities including excessive acidity or diluted flavors.

In another case, there has been a rising concern recently, about excessive sugar in the average American diet, particularly in juices and sodas consumed by children. Diet sodas have been available for many years, but low sugar juices have been undesirable because of their weak flavor. This has led to a recognized need for high quality, low sugar content juices.

Both of these cases require an economical process for removing sugar from fruit juice, while retaining the volatile aroma compounds, which contribute to the flavor of the juice or wine.

There are a number of ways to extract sugar from a liquid. It is known that fractional freezing techniques and the enzymatic breakdown of sugar can be employed but these have serious side effects including cost or undesirable breakdown products. Another method is to use lectins, sugar binding proteins which are known to have high affinity for specific types of sugar. Unfortunately they are costly and tend to form strongly bound complexes that are difficult to reverse. Thus, it is difficult to reuse them after being bound to sugar. In addition some lectins are toxic, which usually precludes their use in food or wine production.

Another way is to use certain semi-permeable chromatographic granular sugar absorbing materials. These are currently used in the sugar refining processes to extract refined sugar from sugar beets as described by Kearney, Kochergin, Peterson, and Velasquez in U.S. Pat. No. 5,466,294, granted Nov. 14, 1995 or to extract high fructose corn syrup from corn as described by Dorta, Dhingra, and Pynnonen in U.S. Pat. 5,176,832 granted Jan. 5, 1993. They contain ligands, which form weak complexes with sugar, and as a result, weakly bind sugar. The weak bond may be broken through the addition of hot water thus reversing the process. By this means the sugar absorbing materials may be reused after removing the sugar with hot water. It is necessary to reuse the sugar absorbing material because of its cost and the small weight of sugar the sugar absorbing material will bind in proportion to its weight.

This disclosure presents a new process for extracting sugar from the fruit juice, which differs from refining sugar because in sugar refining, the non-sugar liquid and solids are removed, and the resulting refined sugar is kept, while in this new process the sugar is removed from juice, and the juice is retained as the desire product. As a result, these two processes have very different objectives.

### SUMMARY OF THE INVENTION

The present invention discloses a method to extract excess sugar from fruit juice using equipment containing sugar-absorbing materials comprising repeatedly performing extraction cycles and cleaning cycles on successive portions of juice, where the sugar absorbing materials may be reusable and may comprise ligand impregnated semi-permeable resin granules or beads. The equipment comprises a centrifuge with a coarse filtration screen and subsystems for incoming juice filtration, nitrogen gas injection, hot and cold water injection, extracted waste sugar water, and extracted low-sugar juice. The extraction cycle comprises injecting a portion of juice into the centrifuge, allowing the juice to maintain contact with the sugar absorbing material for a predetermined period of time, spinning the centrifuge to extract the juice through the screen, injecting nitrogen or other suitably inert gas into the spinning centrifuge to extract the remaining juice through the screen, and extracting the low-sugar juice. The cleaning cycle comprises one or more washing cycles followed by injecting nitrogen or other suitably inert gas into the spinning centrifuge and extracting the remaining waste sugar water, where each washing cycle comprises injecting water into the centrifuge, allowing the water to maintain contact with the sugar absorbing material for a predetermined period of time, spinning the centrifuge and extracting waste sugar water. The cleaning cycles may comprise at least one washing cycle using hot water followed by one washing cycle using cold water.

The present invention also discloses a method to continuously extract excess sugar from fruit juice using equipment containing multiple centrifuges filled with ligand impregnated semi-permeable sugar absorbing materials comprising repeatedly performing an extraction cycle and a cleaning cycle further comprising two washing cycles where each centrifuge is performing a different phase of the repetitive process such that at least one centrifuge is always performing the extraction cycle.

### BRIEF DESCRIPTION OF THE DRAWINGS

The invention will now be described in connection with the attached drawings, in which:

FIG. 1 is a diagram of one embodiment of the equipment,

FIG. 2 is a diagram of a batch sugar removal process,

FIG. 3 is a diagram the equipment containing multiple centrifuges, and

FIG. 4 is a of a continuous sugar extraction process.

### DESCRIPTION OF THE EMBODIMENTS

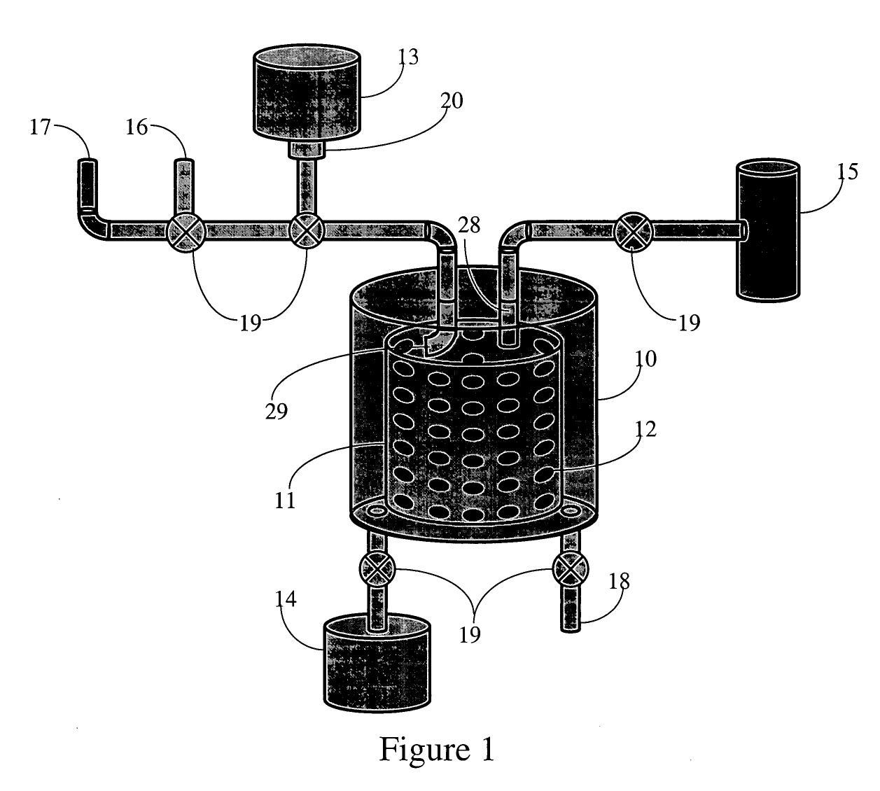

The present invention is now described with reference to FIGS. 1-4, it being appreciated that the figures illustrate the subjects matter and may not be to scale or to measure.

A preferred embodiment of the present invention, equipment for extracting sugar from juice comprises a centrifuge with a coarse filtration screen and subsystems for filtration of incoming juice, nitrogen gas injection, hot and cold water injection, extracted waste sugar water, and extraction of the resulting low-sugar juice.

Reference is now made to FIG. 1, a diagram of one embodiment of the equipment for creating low-sugar juice by extraction of sugar. The equipment consists of a housing 10 containing a centrifuge cylinder 11, which spins at thousands of revolutions per minute within the housing 10. The centrifuge cylinder 11 contains numerous screened holes 12 for the extrusion of the resulting low-sugar juice. The centrifuge is partially filled with sugar absorbing material. The screens across the holes have openings that are smaller than the diameter of the sugar absorbing material, thus insuring the sugar absorbing material remains in the centrifuge cylinder during normal operation. There are pipe connections for hot water 17 and cold water 16, and a tank 13 for the unfiltered juice, which proceeds through a filtration unit 20 before being injected out of a nozzle 29, into the centrifuge cylinder 11. A canister for nitrogen 15, or other suitably inert gas is connected via another nozzle 28 into the top of the centrifuge cylinder 11, to push, under pressure, the residual liquid from between the sugar absorbing material, out of the screen into the larger housing's 10 chamber, where the liquid either exits the chamber through a waste liquid pipe 18, or if it is the low-sugar juice, into a resulting juice container. There are valves 19, which select between injecting hot water, cold water, the original filtered juice, or nitrogen gas into the chamber 10, and extraction of waste sugar water, or the resulting low-sugar juice, out of the chamber after centrifuging the liquid.

In another embodiment of the present invention a batch method for extracting sugar from juice comprises the steps of: repeatedly performing an extraction cycle and a cleaning cycle on successive portions of juice. The extraction cycle further comprises injecting a portion of juice into the centrifuge, spinning the centrifuge to extract the juice through the screen, injecting nitrogen under into the spinning centrifuge to extract the remaining juice through the screen, and extracting the low-sugar juice. The cleaning cycle further comprises one or more washing cycles followed by injecting nitrogen into the spinning centrifuge and extracting the remaining waste sugar water, where each washing cycle comprises injecting water into the spinning centrifuge and extracting waste sugar water thereby removing the sugar from the sugar absorbing material.

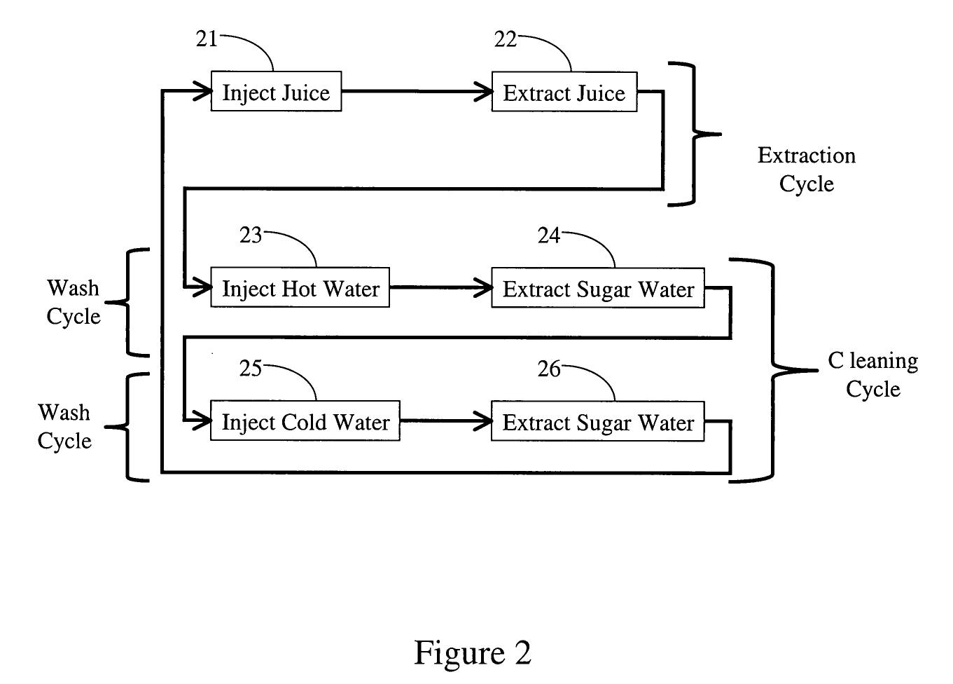

Reference is now made to FIG. 2, a diagram of a batch sugar removal process. The process involves six steps in two cycles. The extraction cycle includes the steps of injecting the juice 21 and extracting the resulting low-sugar juice 22. To facilitate the reduction in sugar the juice is suitably mixed with the sugar absorbing material while injecting it into a centrifuge. To facilitate the complete extraction of the resulting low-sugar juice the centrifuge spins at thousands of revolutions per minute followed after most of the juice has been extracted by injecting nitrogen or some other suitably inert gas under pressure into the spinning centrifuge to extract the remaining juice. At the end of the extraction cycle the ligand impregnated semi-permeable sugar absorbing material has been saturated with sugar that has been removed from the juice without removing any significant fraction of the aromatic compounds, precursors to aromatic compounds, or other organic chemicals that form the aroma, taste, character and nutrition of the juice.

The sugar must be removed from the sugar absorbing material in a cleaning cycle before the material can be reused in further sugar extraction. This is done in a cleaning cycle consisting of at least two washing cycles. The first washing cycle consists of injecting hot water 23 into the centrifuge, which causes the ligands to release most of their sugar, followed by centrifuging to extract the resulting waste sugar water 24. This specific washing cycle may be performed a number of times followed by a washing cycle consisting of injecting cold water 25 and centrifuging and injecting nitrogen to extract the last of the waste sugar water 26, after which the process begins again with an extraction cycle.

It is further contemplated that the resulting low-sugar juice may be re-input into the equipment as many times as necessary to reduce the sugar content in the juice to the desired level.

In another embodiment of the present invention method to continuously extract excess sugar from fruit juice using equipment containing multiple centrifuges filled with ligand impregnated semi-permeable sugar absorbing material comprising repeatedly performing an extraction cycle and a cleaning cycle further comprising two washing cycles where each centrifuge is performing a different phase of the repetitive process such that at least one centrifuge is always performing the extraction cycle, is presented.

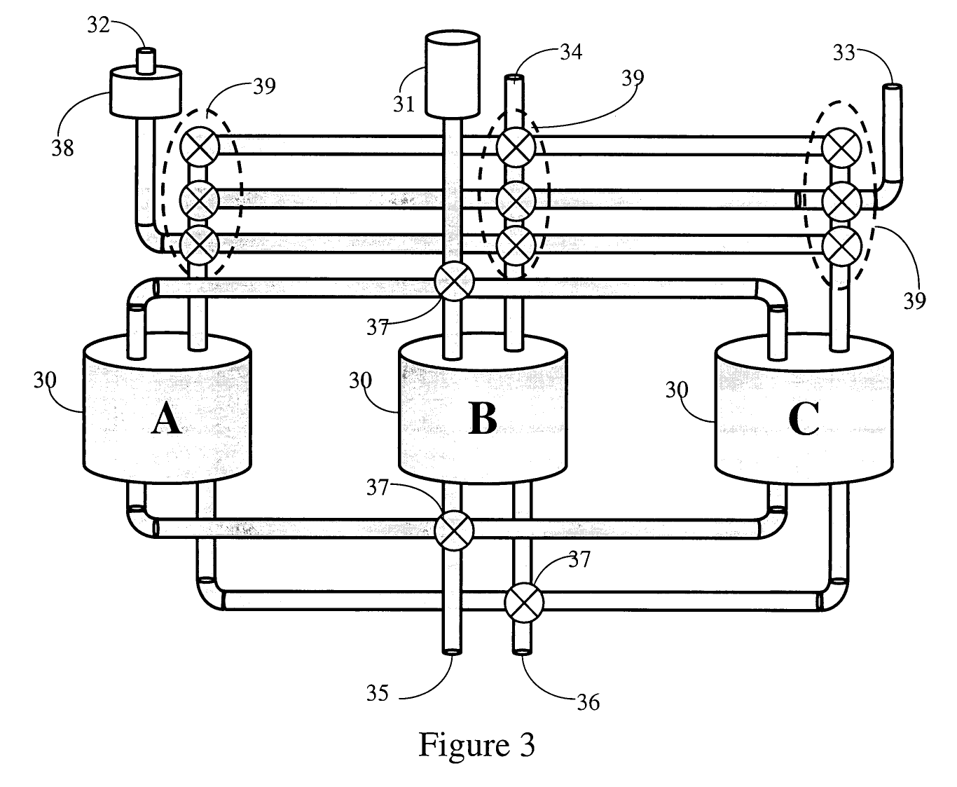

Reference is now made to FIG. 3, a diagram the equipment containing multiple centrifuges. There are inputs for hot water 33, cold water 34, and juice 32, which is filtered through a filtration system 38 before entering the centrifuges 30. There is also a canister 31, for nitrogen or other suitably inert gas cylinder for providing pressurized gas to the centrifuges 30. Each centrifuge also as facilities 35 for extracting the waste sugar water, which are separate from the facilities for extracting the low-sugar juice 36. There are computer controlled valves 37 for selecting from one input to one of the three centrifuges or from one of the three centrifuges to the single output pipe. There are also computer controlled valves 39, for connecting one of the inputs to the input of each of the centrifuges. Typically only one of each of the set of 3 valves 39 is connected to its centrifuge at any given time such that each of the three centrifuges 30 is performing a different cycle of the process at any given time.

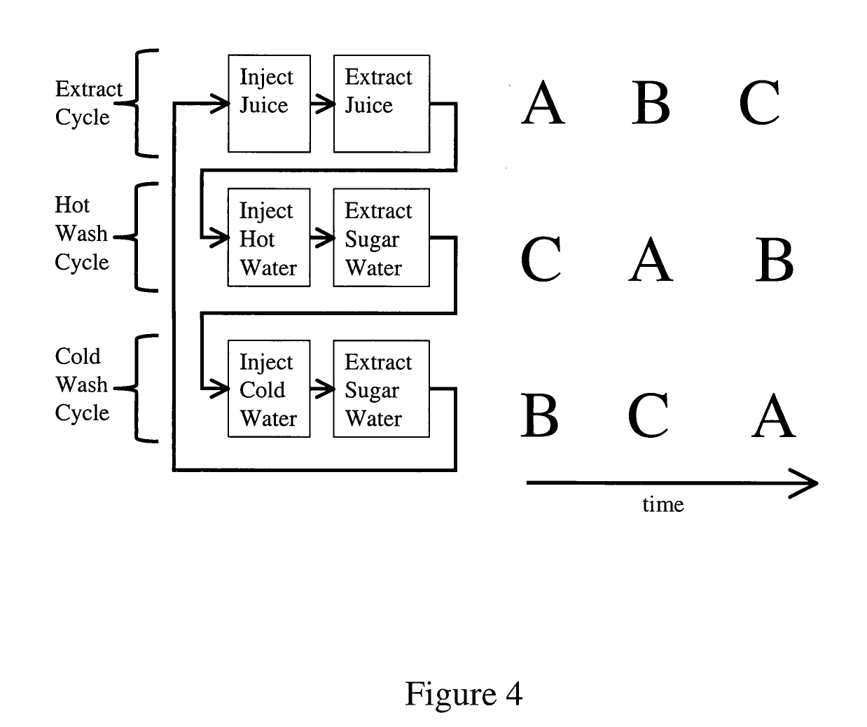

Reference is now made to FIG. 4, diagram of a continuous sugar extraction process. At any given time each centrifuge (A, B or C) is performing a different cycle (Extract, Hot Wash, or Cold Wash), and they continue to rotate performing successive cycles of the process with equal phase offsets to each other because each cycle is designed to take approximately ⅓ of the total cycle time.

In yet another embodiment of the present invention, the equipment may be reduced or extended to include fewer or more than three centrifuges such that the number of centrifuges match the number cycles of equal duration in the process.

In yet another embodiment of the present invention, it is contemplated that the equipment may include the continuous extraction of sugar saturated sugar absorbing materials and the continuous injection of cleaned sugar absorbing materials into a continuously spinning extraction centrifuge, where the sugar saturated sugar absorbing materials are continuously injected into a continuously spinning cleaning centrifuge and the extracted cleaned sugar absorbing materials are continuously extracted from the cleaning centrifuge to be reintroduced into the extraction centrifuge. It is further contemplated that the sizes of each centrifuge and the amount of sugar absorbing materials within each centrifuge are proportional to the amount of time they require within each cycle.

It will be appreciated by persons skilled in the art that the present invention is not limited by what has been particularly shown and described hereinabove. Rather the scope of the present invention includes both combinations and sub-combinations of various features described hereinabove as well as modifications and variations which would occur to persons skilled in the art upon reading the foregoing description and which are not in the prior art.

I claim:

1. A method to extract excess sugar from fruit juice using equipment containing sugar absorbing material comprising repeatedly performing the steps of:
an extraction cycle performed on successive portions of inputted juice; and
a cleaning cycle;
creating successive portions of low sugar juice.

2. A method as in claim 1 wherein the sugar absorbing material is comprised of reusable ligand impregnated semi-permeable granules.

3. A method as in claim 1 wherein the extraction cycle comprises:
injecting a portion of juice into a centrifuge containing sugar absorbing materials that extract sugar from the juice;
spinning the centrifuge to extract the resulting low-sugar juice through screened holes;
injecting nitrogen under pressure into the spinning centrifuge to extract the remaining juice through the screened holes; and
extracting the resulting low-sugar juice from a chamber outside of the centrifuge into an output container.

4. A method as in claim 1 wherein the cleaning cycles comprises the steps of:
at least one washing cycle using hot water;
at least one washing cycle using cold water;
injecting a suitably inert gas under pressure into the spinning centrifuge; and
extracting the remaining waste sugar water.

5. A method as in claim 1 wherein at least one portion low sugar juice is subsequently used as a portion of inputted juice.

6. A method as in claim 1 wherein at least one portion of low sugar juice is subsequently mixed with the inputted juice.

7. A method as in claim 1 wherein the cleaning cycle comprises the steps of:
At least one washing cycles;
injecting a suitably inert gas under pressure into the spinning centrifuge; and
extracting the remaining waste sugar water.

8. A method as in claim 7 wherein the washing cycle comprises:
injecting water into the centrifuge;
spinning the centrifuge; and
extracting waste sugar water from the chamber.

9. Equipment for producing low-sugar juice comprising:
At least one centrifuges with coarse filtration screens and external chambers;
A subsystem for injecting filtered juice into any one of the at least one centrifuges;
A subsystem for injecting hot water into any one of the at least one centrifuges;
A subsystem for injecting cold water into any one of the at least one centrifuges;
A subsystem for injecting a suitably inert gas under pressure into any one of the at least one centrifuges;
A subsystem for extracting waste sugar water from any of the at least one centrifuge chambers; and
A subsystem for extracting the resulting low-sugar juice from any of the at least one centrifuge chambers.

10. A method for continuously extracting sugar from juice; wherein at least one centrifuge is performing an extraction cycle to extract sugar from juice while at least one other centrifuge is performing a cleaning cycle to extract waste sugar water from the sugar absorbing material within the centrifuges.

11. A method as in claim 10 wherein the centrifuges are phased such that at least one centrifuge is performing an extraction cycle at any time during the operation of the equipment.

12. A method as in claim 10, wherein at least twice as many centrifuges are performing cleaning cycles as centrifuges that are performing extraction cycles.

13. A method as in claim 10 wherein the extraction cycle comprises:
injecting a portion of juice into a centrifuge containing sugar absorbing material which extract sugar from the juice;
spinning the centrifuge to extract the resulting low-sugar juice through screened holes;
injecting nitrogen under pressure into the spinning centrifuge to extract the remaining juice through the screened holes; and
extracting the resulting low-sugar juice from a chamber outside of the centrifuge into an output container.

14. A method as in claim 10 wherein the cleaning cycle takes at least twice as long as the extraction cycle.

15. A method as in claim 10 wherein the cleaning cycles comprises the steps of:
at least one washing cycle using hot water;
at least one washing cycle using cold water;
injecting a suitably inert gas under pressure into the spinning centrifuge; and
extracting the remaining waste sugar water;

16. A method as in claim 15 wherein the washing cycle comprises:
injecting water into the centrifuge;
spinning the centrifuge; and
extracting waste sugar water from the chamber.
